(19) United States
(12) Patent Application Publication
(10) Pub. No.: US 2013/0216061 A1
(43) Pub. Date: Aug. 22, 2013

(54) ELECTRONIC DEVICE AND METHOD FOR ENABLING OPEN MOBILE TERMINAL PLATFORM HEADSETS AND STANDARD HEADSETS TO BE COMPATIBLE

(71) Applicant: MING-QUAN MA, Shenzhen City (CN)

(72) Inventor: MING-QUAN MA, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/455,276

(22) Filed: Apr. 25, 2012

(30) Foreign Application Priority Data
Feb. 20, 2012 (CN) 201210038109.5

(51) Int. Cl. H04R 1/10

(52) U.S. Cl. 381/74

(57) ABSTRACT

An electronic device that can enable OMTP headsets and standard headsets to be compatible includes a switch unit. The switch unit includes two switches. Each of the two switches includes a moving contact and two stationary contacts. A standard headset or an OMTP headset can be applied on the electronic device by switching between the moving contact and the two stationary contacts of the two switches.

### BACKGROUND

1. Technical Field

Embodiments of the present disclosure relate to audio technology, and more particularly to an electronic device and a method for enabling an open mobile terminal platform (OMTP) headset and a standard headset to be compatible.

2. Description of Related Art

Open mobile terminal platform (OMTP) is an industry group sponsored by mobile operators and manufacturers interested in supporting universally standard product specifications across the industry. The OMTP specification for 4-pole 3.5 mm headsets, switches the ground (GND) and MIC pins. As shown in FIG. 1, an OMTP headset includes a left (L) audio pin, a right (R) audio pin, a microphone (MIC) pin, and a ground (GND) pin in turn. However, as shown in FIG. 2, a standard 4-pole 3.5 mm headset with a microphone orderly includes a L audio pin, a R audio pin, a GND pin, and a MIC pin in turn.

If connecting a standard headset into an OMTP headset socket or connecting an OMTP headset into a standard headset socket, a user may have the following experiences:
Dampened audio volume;
Inability to use the microphone; and
Inability to use the send/end key on the headset.

Thus, compatibility between the OMTP headset and the standard headset is desired.

### BRIEF DESCRIPTION OF THE DRAWINGS

FIG. 1 and FIG. 2 are respectively a schematic diagram of an OMTP headset and a standard headset.

FIG. 3 is a block diagram of one embodiment of an electronic device.

FIG. 4 is a partial enlarged view in FIG. 3.

FIG. 5 illustrates a flowchart of one embodiment of a method for enabling OMTP headsets and standard headsets to be compatible.

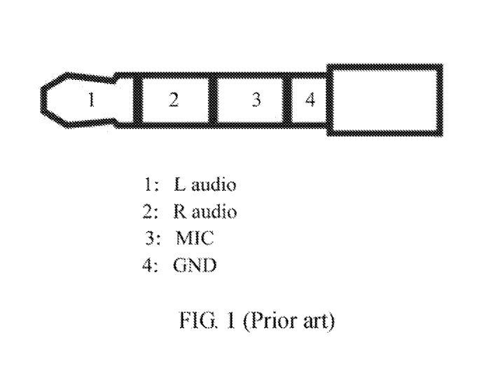

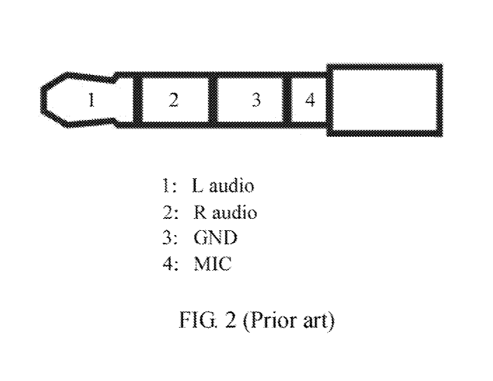

### DETAILED DESCRIPTION

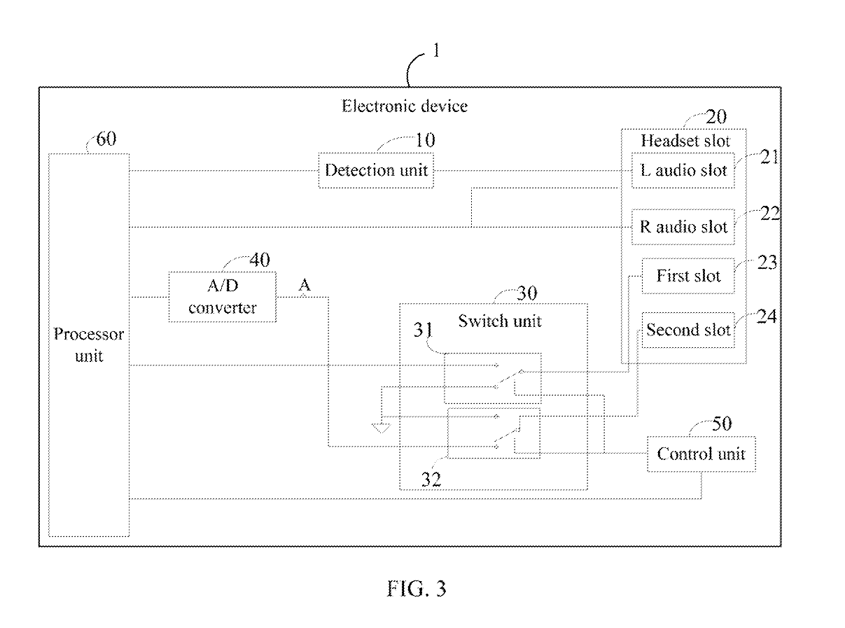

FIG. 3 is a block diagram of one embodiment of an electronic device 1. The electronic device 1 may be a cellular phone, a computer, a personal digital assistant (PDA), for example. In one embodiment, the electronic device 1 may include, but is not limited to, a detection unit 10, a headset socket 20, a switch unit 30, an analog/digital (A/D) converter 40, a control unit 50, and a processor unit 60. The electronic device 1 may further include other components, such as resistors and capacitors which are not shown in FIG. 3.

The headset socket 20 includes a L audio slot 21, a R slot 22, a first slot 23, and a second slot 24. The first slot 23 and the second slot 24 may respectively be a MIC slot and a GND slot, or respectively be a GND slot and a MIC slot according to a headset plugged into the headset socket 20 is an OMTP headset or a standard headset. That is, if an OMTP headset is plugged into the headset socket 20, the first slot 23 and the second slot 24 are a MIC slot and a GND slot respectively. If a standard headset is plugged into the headset socket 20, the first slot 23 and the second slot 24 are a GND slot and a MIC slot respectively.

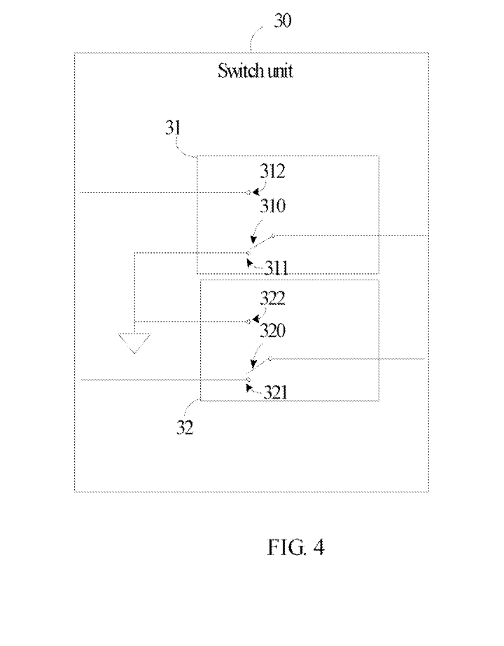

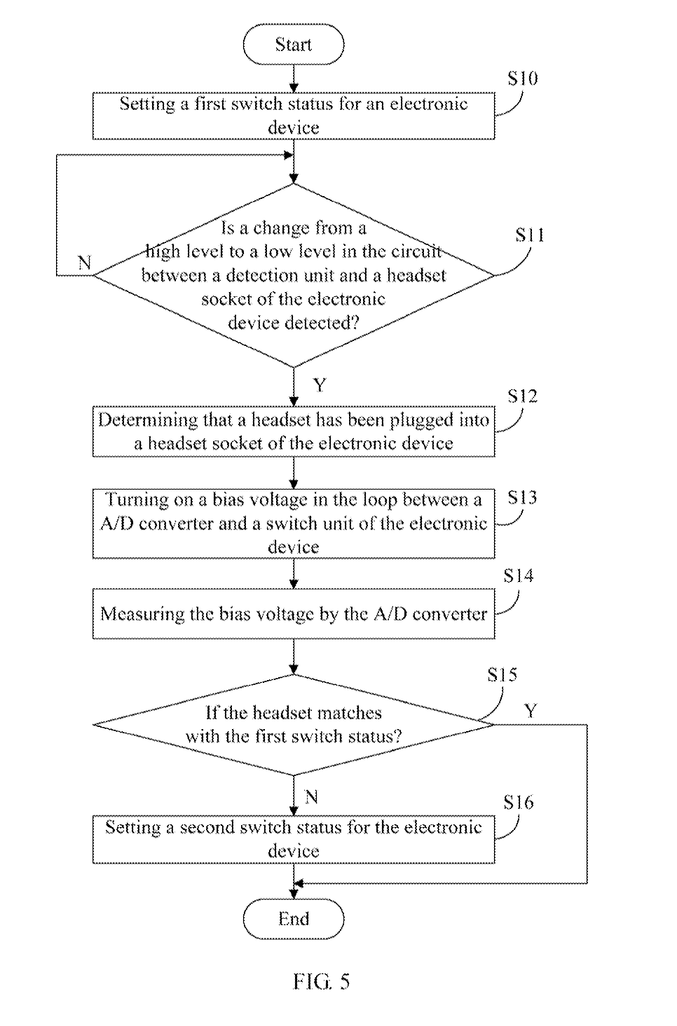

The switch unit 30 includes a first switch 31 and a second switch 32. Each of the first switch 31 and the second switch 32 includes a moving contact and two stationary contacts. FIG. 4 shows the first switch 31 including a first moving contact 310, a first stationary contact 311, and a second stationary contact 312. The second switch 32 includes a second moving contact 320, a third stationary contact 321, and a fourth contact 322.

The detection unit 10 connects with the L audio slot 21 of the headset socket 20, and detects if a headset has been plugged into the headset socket 20. When a L audio pin of a headset touches with the L audio slot 21, the detection unit 10 may detect a change from a high level to a low level in the circuit between the detection unit 10 and the headset socket 20, thus, the detection unit 10 determines that there is a headset being plugged into the headset socket 20.

The L audio slot 21 and the R audio slot 22 connects with the processor unit 60, and receives audio data, such as music, from the processor unit 60.

The first slot 23 connects with the first moving contact 310 of the first switch 31, and the second slot 24 connects with the second moving contact 320 of the second switch 32.

The first switch 31 and the second switch 32 connect with the control unit 50. The first stationary contact 311 of the first switch 31 and the fourth stationary contact 322 of the second switch 32 connect with ground. The second stationary contact 312 of the first switch 31 and the third stationary contact 321 of the second switch 32 connect with the processor unit 60 and the A/D converter 40.

The control unit 50 controls the first moving contact 310 to contact with the first stationary contact 311 in the first switch 31 and the second moving contact 320 to contact with the third stationary contact 321 in the second switch, or controls the first moving contact 310 to contact with the second stationary contact 312 in the first switch 31 and the second moving contact 320 to contact with the fourth stationary contact 322 in the second switch 32.

As seen in FIG. 3, when the first moving contact 310 contacts with the first stationary contact 311 in the first switch 31 and the second moving contact 320 contacts with the third stationary contact 321 in the second switch 32, the first slot 23 and the second slot 24 in the headset socket 20 are the GND slot and the MIC slot respectively. When the first moving contact 310 contacts with the second stationary contact 312 in the first switch 31 and the second moving contact 320 contacts with the fourth stationary contact 322 in the second switch 32, the first slot 23 and the second slot 24 in the headset socket 20 are the MIC slot and the GND slot respectively.

The A/D converter 40 measures a bias voltage in the circuit between the A/D converter 40 and the switch unit 30. The bias voltage is used to determine if a current switch status of the electronic device 1 matches with a headset that is plugged into the headset socket 20. The electronic device 1 may include a first and a second switch status. The first switch status of the electronic device 1 may be defined as the first moving contact 310 contacting with the first stationary contact 311 in the first switch 31 and the second moving contact 320 contacting with the third stationary contact 321 in the second switch 32. The second switch status of the electronic device 1 may be defined as the first moving contact 310 contacting with the second stationary contact 312 in the first switch 31 and the second moving contact 320 contacting with the fourth stationary contact 322 in the second switch 32.

If the bias voltage approaches 1 Volt, it is determined that the current switch status of the electronic device 1 matches with a headset plugged into the headset socket 20. That is, the current switch status of the electronic device 1 is the first switch status and the headset plugged into the headset socket 20 is a standard headset. Otherwise, the current switch status of the electronic device 1 is the second switch status and the headset plugged into the headset socket 20 is an OMTP headset.

If the bias voltage approaches 0 Volt, it is determined that the current switch status of the electronic device 1 does not match with a headset plugged into the headset socket 20. That is, the current switch status of the electronic device 1 is the first switch status while the headset plugged into the headset socket 20 is an OMTP headset. Otherwise, the current switch status of the electronic device 1 is the second switch status while the headset plugged into the headset socket 20 is a standard headset.

When the current switch status of the electronic device 1 does not match with the headset plugged into the headset socket 20, the control unit 50 needs to set another switch status for the electronic device 1.

FIG. 3 illustrates a flowchart of one embodiment of a method for enabling OMTP headsets and standard headsets to be compatible. Depending on the embodiment, additional steps may be added, others removed, and the ordering of the blocks may be changed.

In step S10, the processor unit 60 controls the control unit 50 to set a first switch status for the electronic device 1. As mentioned above, the first switch status is defined as the first moving contact 310 contacting with the first stationary contact 311 in the first switch 31 and the second moving contact 320 contacting with the third stationary contact 321 in the second switch 32.

In step S11, the processor unit 60 controls the detection unit 10 to detect a change from a high level to a low level in the circuit between the detection unit 10 and the headset socket 20. Step S12 is implemented if the detection unit 10 detects such change. Otherwise, step S11 is repeated if the detection unit 10 does not detect such change.

In step S12, the processor unit 60 determines that there is a headset being plugged into the headset socket 20. The headset may be a OMTP headset or a standard headset.

In step S13, the processor unit 60 turns on a bias voltage in the circuit between the A/D converter 40 and the switch unit 30.

In step S14, the processor unit 60 controls the A/D converter 40 to measure the bias voltage.

In step S15, the processor unit 60 determines if the headset plugged into the headset socket 20 matches with the first switch status according to the bias voltage. When the bias voltage approaches 1 Volt, it is determined that the headset plugged into the headset socket 20 matches with the first switch status, and then step S17 is implemented. Otherwise, when the bias voltage approaches 0 Volt, it is determined that the headset plugged into the headset socket 20 does not match with the first switch status, then step S16 is implemented.

In step S16, the processor unit 60 controls the control unit 50 to set a second switch status for the electronic device 1. As mentioned above, the second switch status is defined as the first moving contact 310 contacting with the second stationary contact 312 in the first switch 31 and the second moving contact 320 contacting with the fourth stationary contact 322 in the second switch 32. In the present embodiment, the second switch status must match with the headset plugged into the headset socket 20, and then step S17 is implemented.

In step S17, the headset plugged into the headset socket 20 outputs the audio data received from the processor unit 60

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. An electronic device comprising a detection unit, a headset socket, an analog/digital (A/D) converter, and a processor unit, wherein the headset socket comprises a left (L) audio slot, a right (R) audio slot, a first slot, and a second slot, the L audio slot connects with the detection unit and the processor unit, and the R audio slot connects with the processor unit, the electronic device further comprises:
a switch unit comprising a first switch and a second switch; and
a control unit connected with the switch unit;
the first switch comprising a first moving contact, a first stationary contact, and a second stationary contact, and the second switch comprising a second moving contact, a third stationary contact, and a fourth stationary contact;
the first moving contact of the first switch connecting with the first slot, and the second moving contact of the second switch connecting with the second slot;
the first stationary contact and the fourth stationary contact connect with ground (GND), and the second stationary contact and the third stationary contact connects with the A/D converter and the processor unit.

2. The electronic device according to claim 1, wherein the detection unit detects a change from a high level to a low level in the circuit between the detection unit and the headset socket to determine if a headset has been plugged into the headset socket.

3. The electronic device according to claim 2, wherein the headset is a standard headset which includes a left (L) audio pin, a right (R) audio pin, a ground (GND) pin, and a microphone (MIC) pin in turn.

4. The electronic device according to claim 2, wherein the headset is an open mobile terminal platform (OMTP) headset which includes a left (L) audio pin, a right (R) audio pin, a microphone (MIC) pin, and a ground (GND) pin in turn.

5. The electronic device according to claim 2, wherein the control unit sets a first switch status for the electronic device by controlling the first moving contact to contact with the first stationary contact and the second moving contact to contact with the third stationary contact.

6. The electronic device according to claim 5, wherein the A/D converter measures a bias voltage in the circuit between the A/D converter and the switch unit.

7. The electronic device according to claim 6, wherein the processor unit determines if the first switch status matches with the headset according to bias voltage.

8. The electronic device according to claim 7, wherein the first switch status matches with the headset when the bias voltage approaches 1 Volt.

9. The electronic device according to claim 7, wherein the first switch status does not match with the headset when the bias voltage approaches 0 Volt.

10. The electronic device according to claim 9, wherein the control unit sets a second switch status for the electronic device by controlling the first moving contact to contact with the second stationary contact and the second moving contact to contact with the fourth stationary contact, when the first switch status does not match with the headset.

11. A method for enabling open mobile terminal platform (OMTP) headsets and standard headsets to be compatible using the electronic device according to claim 1, wherein the method comprises:
setting a first switch status for the electronic device;
determining a headset being plugged into the headset socket of the electronic device when a change from a high level to a low level in the circuit between the detection unit and the headset socket is detected;
turning on a bias voltage in the circuit between the A/D converter and the switch unit, and measuring the bias voltage;
determining if the headset plugged into the headset socket matches with the first switch status according to the bias voltage; and
setting a second switch status for the electronic device upon condition that the headset plugged into the headset socket does not match with the first switch status.

12. The method according to claim 11, wherein the first switch status is defined as the first moving contact contacting with the first stationary contact in the first switch and the second moving contact contacting with the third stationary contact in the second switch.

13. The method according to claim 11, wherein the headset plugged into the headset socket is a standard headset which includes a left (L) audio pin, a right (R) audio pin, a ground (GND) pin, and a microphone (MIC) pin in turn.

14. The method according to claim 11, wherein the headset is an OMTP headset which includes a left (L) audio pin, a right (R) audio pin, a microphone (MIC) pin, and a ground (GND) pin in turn.

15. The method according to claim 11, the headset plugged into the headset socket is determined matching with the first switch status when the bias voltage approaches 1 Volt.

16. The method according to claim 11, the headset plugged into the headset socket is determined not matching with the first switch status when the bias voltage approaches 0 Volt.

17. The method according to claim 11, wherein the second switch status is defined as the first moving contact contacting with the second stationary contact in the first switch and the second moving contact contacting with the fourth stationary contact in the second switch.
